(19) United States
(12) Patent Application Publication
(10) Pub. No.: US 2004/0122858 A1
(43) Pub. Date: Jun. 24, 2004

(54) Apparatus and method for content risk management

(76) Inventor: Scott H. Clearwater, Portola Valley, CA (US)

Correspondence Address: HEWLETT-PACKARD COMPANY, Intellectual Property Administration, P.O. Box 272400, Fort Collins, CO, 80527-2400, US

(21) Appl. No.: 10/326,702

(22) Filed: Dec. 23, 2002

(51) Int. Cl. G06F 17/00

(52) U.S. Cl. 707/104.1

(57) ABSTRACT

A method and corresponding apparatus for content risk management use a content risk management (CRM) system to automatically quantify content risk of documents and construct the documents with improved document value. The CRM system creates a risk profile using a combination of publisher and user preferences, and then automatically constructs the documents (content collections and layouts of the content) using the risk profile. As a result, the CRM system automatically reduces content risk of a badly perceived document, efficiently constructing a high value document.

### CROSS-REFERENCE TO RELATED PATENT APPLICATIONS

This application is related to commonly assigned U.S. patent application Ser. No. 10/______ (Attorney Docket No. 100202496-1), entitled “APPARATUS AND METHOD FOR MARKET-BASED DOCUMENT CONTENT AND LAYOUT SELECTION” to Scott H. CLEARWATER; U.S. patent application Ser. No. 10/______ (Attorney Docket No. 100202497-1), entitled “APPARATUS AND METHOD FOR MARKET-BASED DOCUMENT CONTENT SELECTION” to Scott H. CLEARWATER; U.S. patent application Ser. No. 10/______ (Attorney Docket No. 10019008-1), entitled “APPARATUS AND METHOD FOR DOCUMENT CONTENT TRADING” to Scott H. CLEARWATER, et al.; U.S. patent application Ser. No. 10/______ (Attorney Docket No. 100110399-1), entitled “APPARATUS AND METHOD FOR MARKET-BASED GRAPHICAL GROUPING” to Henry W. SANG, Jr., et al., and U.S. patent application Ser. No. 10/______ (Attorney Docket No. 10019320-1), entitled “APPARATUS AND METHOD FOR MARKET-BASED DOCUMENT LAYOUT SELECTION” to Henry W. SANG, Jr., et al., all of which are concurrently herewith being filed under separate covers, the subject matters of which are herein incorporated by reference.

### TECHNICAL FIELD

The technical field relates to document management systems, and, in particular, to document content risk management systems.

### BACKGROUND

The advent of the Internet and desktop publishing has drastically altered the magnitude and variety of documents published. Highly customized documents can be created for a reasonable cost, and users are no longer forced to consume a one-size-fits-all product due in part to the large setup and production costs in older systems.

However, current documents are generally not tailored to the context of use. Since publishers want to produce high quality documents with good assurance to their specific interest, the ability to tailor content becomes increasingly important. With tailored content, publishers can automatically and intelligently access and manage which content has a reasonable upside potential and a manageable downside risk.

Content risk is an important constituent that associates with document publishing. Currently, managing content risk is a completely manual and laborious process. Since content risk is not quantified, its effects are unknown and ignored. Even if some notion of content risk is recognized, the risk is generally handled in an ad hoc fashion, often leading to poor results.

### SUMMARY

A method for content risk management includes generating one or more distributions of features of a document that includes one or more objects, and calculating a risk parameter using the one or more distributions of features. The risk parameter defines risks of the objects and a risk of the document. The method further includes interacting with a market-based trading system with a broker regarding the risk parameter, and consummating a trade among the one or more objects using the broker to reduce the risk of the document.

A corresponding apparatus for content risk management includes a market-based trading system that in turn includes a broker capable of consummating a trade among one or more objects in a document based on user profiles and a content risk management (CRM) system. The CRM system includes a content risk manager capable of interacting with the broker, generating one or more distributions of features of the document, and calculating a risk parameter using the one or more distributions of features. The risk parameter defines risks of the objects and a risk of the document, and the broker consummates a trade among the one or more objects to reduce the risk of the document.

### DESCRIPTION OF THE DRAWINGS

The preferred embodiments of the method and apparatus for content risk management will be described in detail with reference to the following figures, in which like numerals refer to like elements, and wherein:

FIGS. 1A-1C illustrate exemplary risk profiles using three examples;

FIG. 2 illustrates an exemplary content risk management (CRM) system that interacts with an exemplary market-based content selection system, according to one embodiment of the present invention;

FIG. 3 illustrates how the CRM system of FIG. 2 can be used to leverage content value while reducing content risk, according to another embodiment of the present invention;

FIGS. 4-6 illustrate exemplary operations of the CRM system of FIG. 2;

FIGS. 7A and 7B illustrate an example of improving risk profile of a document by removing content, according to another embodiment of the present invention; and

FIG. 8 illustrates exemplary hardware components that may be used in connection with the method for content risk management, according to another embodiment of the present invention.

### DETAILED DESCRIPTION

A method and corresponding apparatus for content risk management use a content risk management (CRM) system to automatically quantify content risk of documents and construct the documents with improved document value. The CRM system creates a risk profile using a combination of publisher and user preferences, and then automatically constructs the documents (content collections and layouts of the content) using the risk profile. As a result, the CRM system automatically reduces content risk of a badly perceived document, efficiently constructing a high value document.

A document is defined generally as a collection or portfolio of content organized and presented in a certain format. Content refers to text, images, layout, artifact or the like. Risk refers to the variation in value that a particular group of users will attach to a particular document and its possible value, or loss of value versus another form of the document. Risk is used here as a measure of the chance that a consumer of the content will not like the content. Content risk refers to the variation in value of a document due to variation in content and the intended audience, i.e., user. The form of the document refers not only to the text and pictures, but also to the layout, i.e., the presentation of the content.

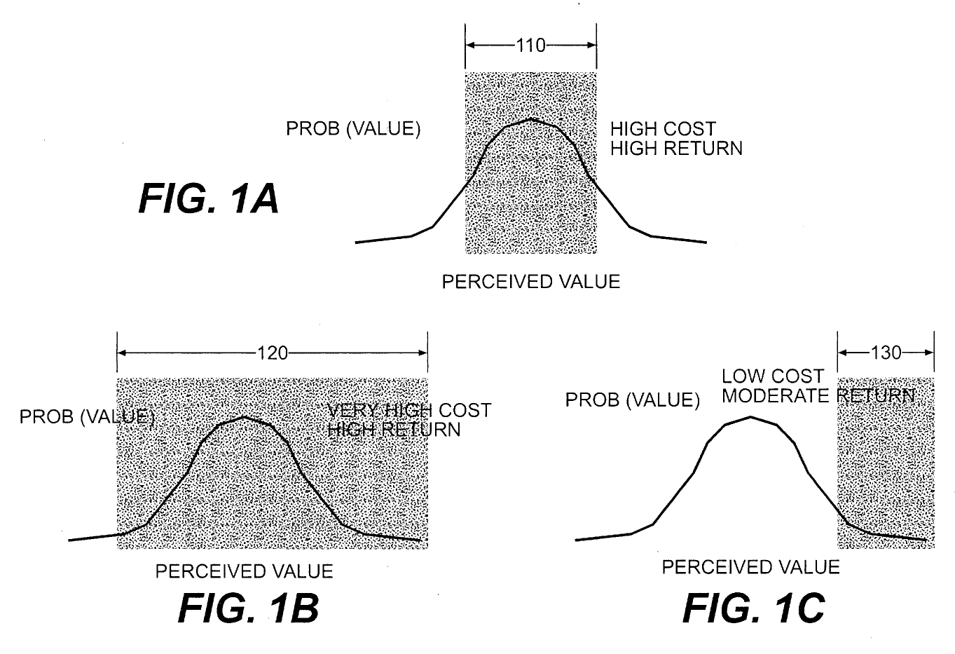

FIGS. 1A-1C illustrate exemplary risk profiles using three examples. Referring to FIG. 1A, a publisher wants to create a document with appeal to a mainstream audience 110, the cost of publication is typically high, but so may be the potential payoff. Referring to FIG. 1B, another publisher tries to reach an even larger audience 120 with an even greater cost. Referring to FIG. 1C, yet another publisher targets a high value niche market 130 that has a low cost but potential high return.

The CRM system utilizes featurized content, i.e., meta-data of content, and user preference profiles to create a less-risky content portfolio. The system hedges the publisher against poor reviews while maintaining or enhancing the upside potential for content value. Any dispersion in the content or the user preferences may indicate that content risk exists. Different users have different perspectives with respect to content value. All the content and user preferences that are folded into value may be reduced to a scalar, such as price. For example, a sheaf of paper stapled together in the upper left corner is perceived as less valuable than the same content stapled through the middle and folded into a booklet.

Content risk can be determined using portfolio theory from financial markets if historical data of a particular kind or class of documents exists, such as buyer preferences from catalog sales. Examples of portfolio theory for risk determination include Bayesian probability techniques, i.e., prior probability estimates, or other estimates from historical sources. In addition, devices may be used to autocreate the metadata needed for content featurization. For example, a word frequency check may be used to pick out keywords, or an image recognition system may be used to pick out or classify an image.

The CRM system can be used to minimize content risk with respect to a prospective target audience. The CRM system can also be used with respect to an already existing audience. In addition, the CRM system can be used in a volatile environment where the audience's preference are dynamic. This functionality is important in Internet publishing where viewership and content can be unstable and where maintaining or growing eyeballs is vital. With the CRM system, a publisher has the ability to manage the content portfolio at the individual document level, and at the ensemble of all documents of the publisher. Thus, the publisher can make a more informed decision about whether to publish a particular work depending on how it affects his overall publication portfolio.

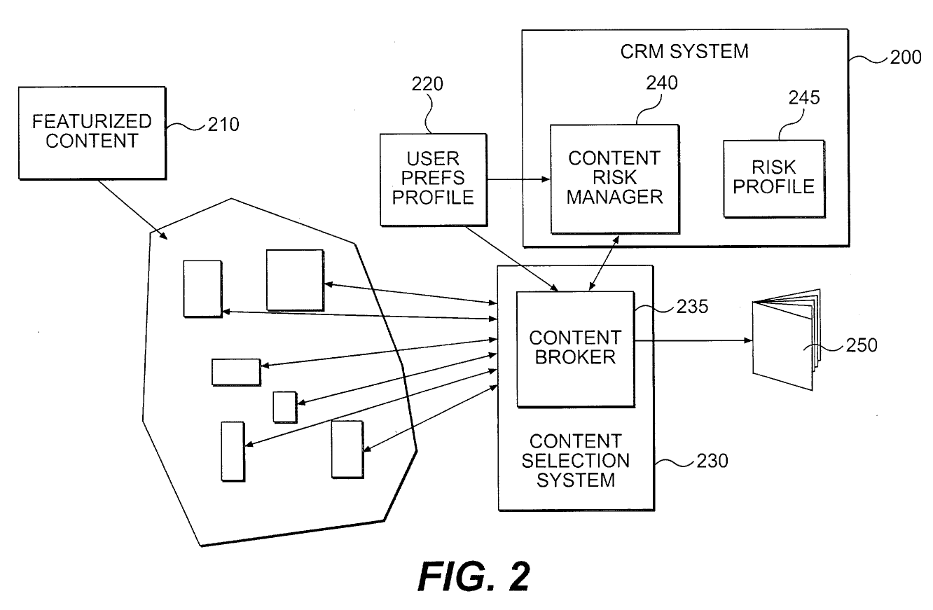

FIG. 2 illustrates an exemplary CRM system 200 that interacts with an exemplary market-based content selection system 230. The CRM system 200 may interact with a market-based trading system that coordinates trading among the document objects. Market-based trading systems have been used in a wide variety of applications to optimize the performance of a computer system or to allocate resources. For example, market-based content selection or layout selection systems automatically consummate trades among objects in a documents based on user preferences, efficiently generating high value documents. FIG. 2 is illustrated with the market-based content selection system 230. However, one skilled in the art will appreciate that the market-based layout selection system and other market-based trading systems can be equally applied.

Referring to FIG. 2, the CRM system 200 includes a content risk manager 240 that interacts with the content selection system 230. The content selection system 230 may include a content broker 235 and may have input from featurized content 210. The featurized content 210 may include content elements with different features, such as size, color, font used, image quality, writing quality or the like. One skilled in the art will appreciate that other content element features can be applied equally well. The featurized content 210 may be combined with user preference profiles 220. The user preference profiles 220 (user profiles) may include criteria for user preferences and biases.

The content risk manager 240 may access risk of a document and create a risk profile 245 based on the inputs from the featurized content 210 and the user profiles 220. The risk profile 245 may include one or more risk parameters, such as size and color predominance of an image, orientation of the image, quality of the image or the like. For example, a user may specify high quality images as one of the user preferences, and a risk profile may be created to include quality of image as one of the risk parameters. After the CRM system 200 analyzes the document, the CRM system 200 may report back either to the user or to the content broker 235. The user or the content broker 235 may then modify the document, by, for example, removing certain content or rearranging the content, generating a new document 250 with lower associated risk. Even with a lower overall apparent value, the new document 250 may be more valuable than a non-risk adjusted document.

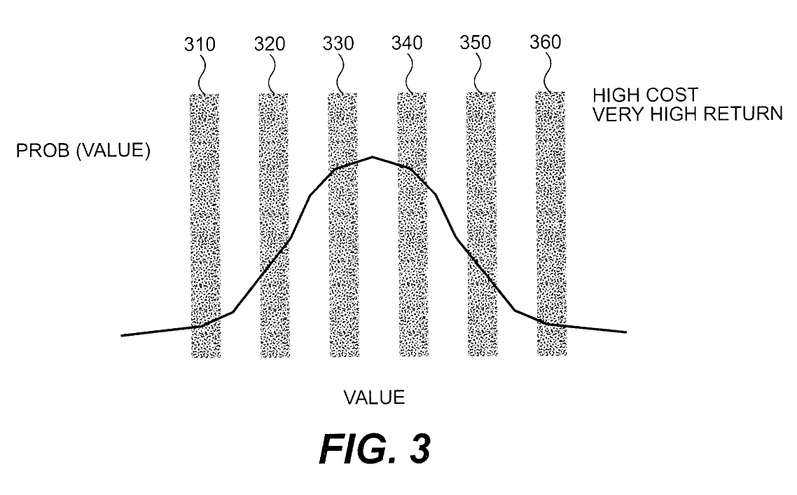

FIG. 3 illustrates how the CRM system can be used to leverage content value while reducing content risk. For example, if a custom published test booklet is designed so that even the poorest student can work through the booklet, the average and gifted students will likely be bored. Consequently, the students (users) tend to attach a low overall value to the test booklet. By utilizing the CRM system, a publisher can tailor the expected overall value of a document to any particular context. For example, in a heterogeneous environment of student abilities, a test booklet may be designed to please most of the students, i.e., the level of difficulty is designed to suit most of the student's ability. On the other hand, as shown in FIG. 3, a collection of test booklets may be published with the CRM system and tailored to targeted audiences, 210, 220, 230, 240, 250, 260. One example of such targeted audiences may be people with visual deficits.

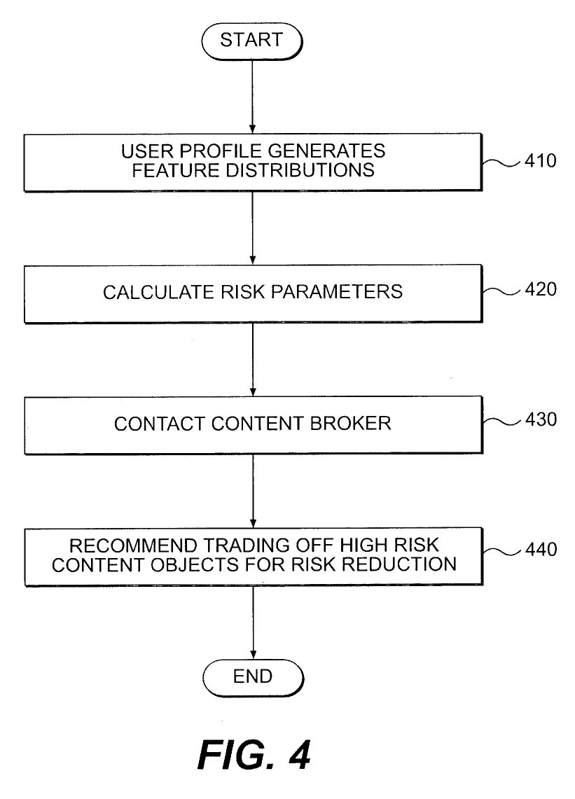

FIGS. 4-6 illustrate exemplary operations of the CRM system 200, interacting with the market-based content selection system 230. One skilled in the art will appreciate that the CRM system 200 can be implemented with the market-based layout selection system and other market-based trading systems.

FIG. 4 is a flow chart illustrating a first embodiment of the exemplary method of content risk management, which is based on user preference profiles 220. First, user profiles 220 generates distributions of features (block 410). For example, the user profile 220 may select one of the content element features, such as size of an image, and describe how many of the featured characteristic exist and how the features are distributed. Next, the distributions of features may be used to calculate risk parameters (block 420), such as standard deviation and percentiles, or other measures of risk. For example, the risk parameters may include size and color predominance of an image, orientation of the image, quality of the image or the like. Next, the content risk manager 240 contacts the content broker 235 regarding the risk (block 430). If the risk is too high, the content broker 235 trades off high risk content objects for lower risk objects (block 440), even if the overall value of the page and the document is lowered.

This embodiment identifies at-risk users because of the user's dispersion in value preferences. The CRM system 200 either removes certain users from receiving the publication, or targets content to reach those at-risk class of users.

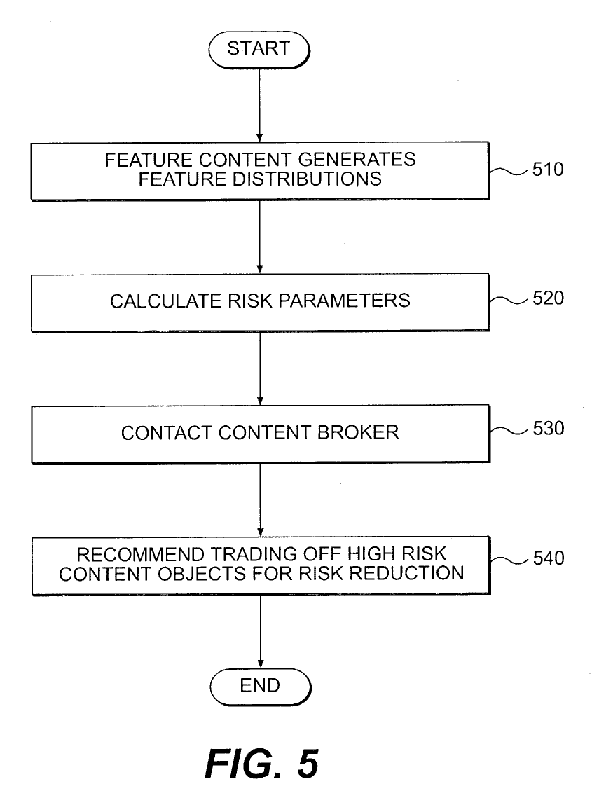

FIG. 5 is a flow chart illustrating a second embodiment of the exemplary method of content risk management, which is based on the featurized content 210. First, the featurized content 210 generates distributions of features (block 510). Then, the distributions are used to calculate risk parameters (block 520), such as standard deviation and percentiles, or other measures of risk. Next, the content risk manager 240 contacts the content broker 235 regarding the risk (block 530). If the risk is too high, the content broker 235 trades off high risk content objects for lower risk objects (block 540), even if the overall value of the page and the document is lowered.

This embodiment identifies at-risk content because of the dispersion in the content. The CRM system 200 removes certain content to lower the overall content risk, or to break up the publication for multiple targeted sub-groups of users.

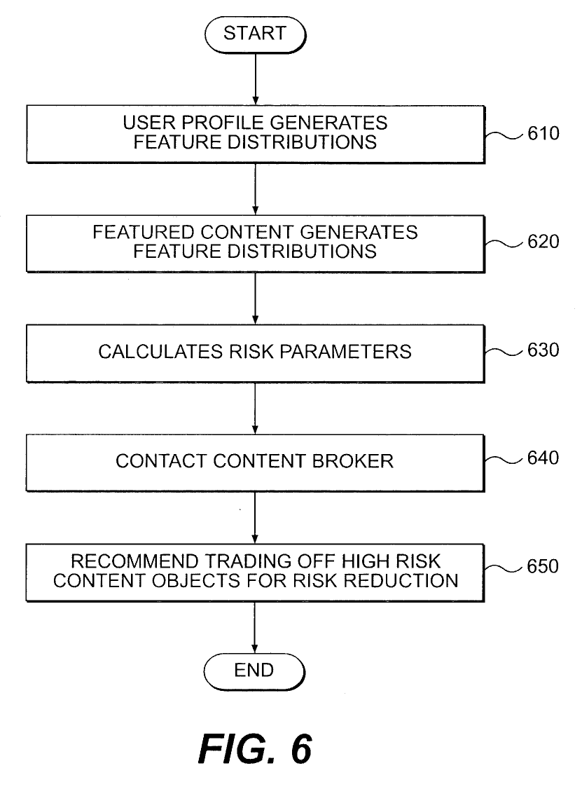

FIG. 6 is a flow chart illustrating a third embodiment of the exemplary method of content risk management, which is based on information from the user profiles 220 and the featurized content 210. First, user profiles 220 generate distributions of features (block 610). Then, featurized content 210 generates distributions of features (block 620). Next, distributions are used to calculate risk parameters (block 630), such as standard deviation and percentiles, or other measures of risk for user profiles and content. Then, the content risk manager 240 contacts the content broker 235 regarding the risk (block 640). If the risk is too high, the content broker 235 trades off high risk content objects for lower risk objects (block 650), even if the overall value of the page and the document is lowered.

This embodiment identifies both at-risk content and users, either of which can be traded off against each other to trade off value and content risk.

The CRM system 200 has broad range of applicability. For example, the CRM system 200 can help construct documents involving spatial designs, such as catalog design, personal accessories portfolio, or even architectural plans for homes or factories. The CRM system 200 can also be used for scheduling where particular tasks need to be performed at particular times. In addition, the CRM system 200 is useful for publishers first constructing a content portfolio as well as publishers seeking to reduce risk of their current content portfolio.

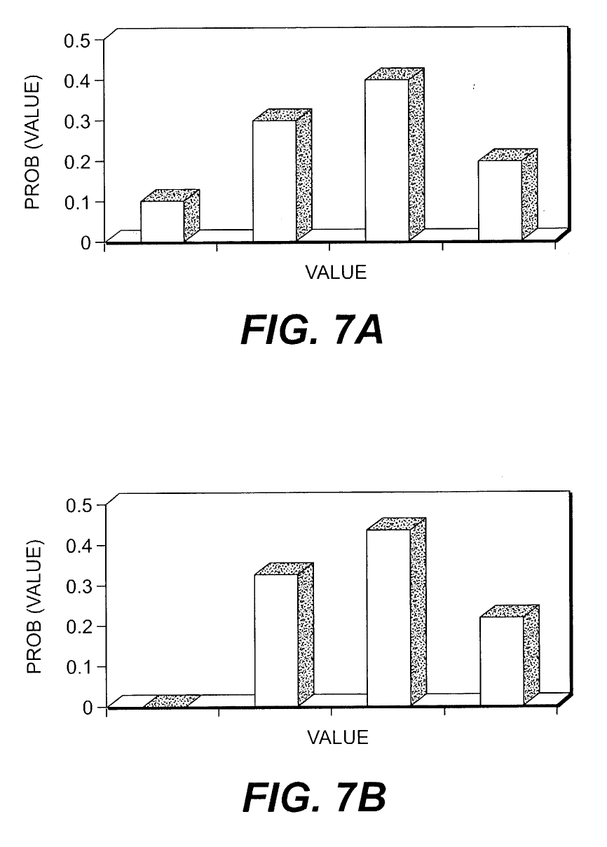

FIGS. 7A and 7B illustrate an example of improving risk profile 245 of a document by removing content. The figures shows the probability distribution of the value of the pages in a booklet. FIG. 7A illustrates value distribution before content risk management. About ten percent of the pages have a relatively low value compared to the other pages based on user preference profiles 220. FIG. 7B illustrates value distribution after content risk management. The least valuable content is removed, yielding a higher overall value to the document.

The content removal procedure may be implemented in different methods. For example, the following metric can be used:

if(value[page]<(value)−2×σ) then delete [page]

(value) is the average value of the pages in the document, and Cσ is the standard deviation of the value of the pages in the document. This metric removes pages more than two standard deviations below value from the mean. However, means can be greatly influenced by outliers, so a more stable measure is to use a percentile, such as the following example:

if(value[page]<value(10^{th} percentile)) then delete [page]

This equation deletes the bottom ten percent of the pages, and can be further elaborated by using the value distribution to compute a confidence level in the percentile, such as the following example:

if(value[page]<value(clocument, CL=90%, 10'h percentile)) then delete [page]

value(document, CL=90%, 10^{th} percentile) represents the value of a page where the publisher is ninety percent confident that ninety percent of the value is higher than this value. The bottom ten percent of the pages may then be removed. These measures may be applied at the page object level rather than the entire page level. If an object is composed of multiple elements, the CRM system 200 may ensure that each element is in close proximity to other related elements in the object.

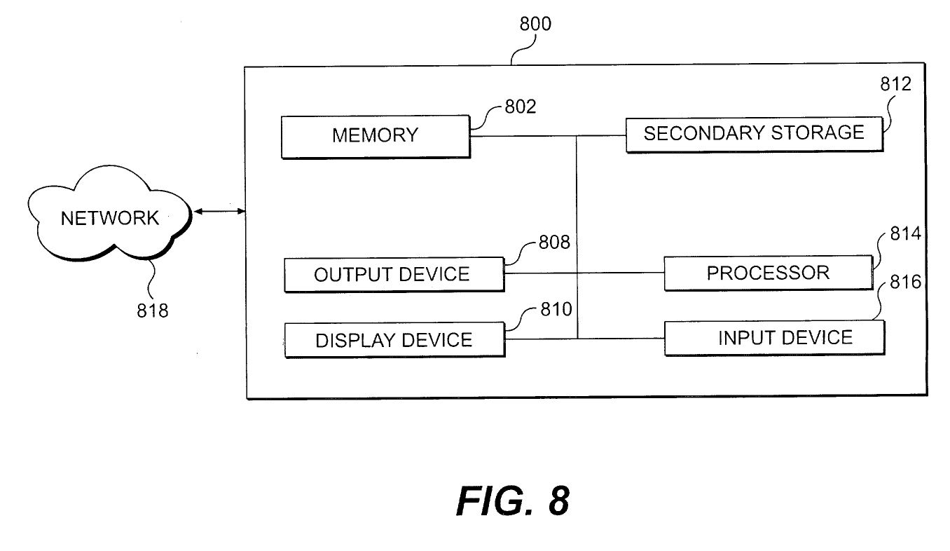

FIG. 8 illustrates exemplary hardware components of a computer 800 that may be used in connection with the method for content risk management. The computer 800 includes a connection with a network 818 such as the Internet or other type of computer or telephone network. The computer 800 typically includes a memory 802, a secondary storage device 812, a processor 814, an input device 816, a display device 810, and an output device 808.

The memory 802 may include random access memory (RAM) or similar types of memory. The secondary storage device 812 may include a hard disk drive, floppy disk drive, CD-ROM drive, or other types of non-volatile data storage, and may correspond with various databases or other resources. The processor 814 may execute information stored in the memory 802, the secondary storage 812, or received from the Internet or other network 818. The input device 816 may include any device for entering data into the computer 800, such as a keyboard, keypad, cursor-control device, touch-screen (possibly with a stylus), microphone or the like. The display device 810 may include any type of device for presenting visual image, such as, for example, a computer monitor, flat-screen display, display panel or the like. The output device 808 may include any type of device for presenting data in hard copy format, such as a printer or printing device, and other types of output devices including speakers or any device for providing data in audio form. The computer 800 can possibly include multiple input devices, output devices, and display devices.

Although the computer 800 is depicted with various components, one skilled in the art will appreciate that the computer 800 can contain additional or different components. In addition, although aspects of an implementation consistent with the method for content risk management are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 800 to perform a particular method.

While the method and apparatus for content risk management have been described in connection with an exemplary embodiment, those skilled in the art will understand that many modifications in light of these teachings are possible, and this application is intended to cover any variations thereof.

What is claimed is:

1. A method for content risk management, comprising:
generating one or more distributions of features of a document, wherein the document includes one or more objects;
calculating a risk parameter using one or more distributions of features, wherein the risk parameter defines risks of the one or more objects and a risk of the document;
interacting with a market-based trading system regarding the risk parameter, wherein the market-based trading system includes a broker; and
consummating a trade among the one or more objects using the broker to reduce the risk of the document.

2. The method of claim 1, wherein the generating step includes generating the one or more distributions of features based on user profiles.

3. The method of claim 1, wherein the generating step includes generating the one or more distributions of features based on featurized content.

4. The method of claim 1, wherein the generating step includes generating the one or more distributions of features based on user profiles and featurized content.

5. The method of claim 1, wherein the calculating step includes calculating the risk parameter using standard deviation and percentile.

6. The method of claim 1, wherein the interacting step includes interacting with a market-based content selection system, wherein the market-based content selection system includes a content broker.

7. The method of claim 1, wherein the interacting step includes interacting with a market-based layout selection system, wherein the market-based layout selection system includes a layout broker.

8. An apparatus for content risk management, comprising:
a market-based trading system, comprising:
a broker capable of consummating trades among one or more objects in a document based on user profiles; and
a content risk management (CRM) system, comprising:
a content risk manager capable of interacting with the broker, generating one or more distributions of features of the document, and calculating a risk parameter using the one or more distributions of features, wherein the risk parameter defines risks of the one or more objects and a risk of the document,
wherein the broker consummates a trade among the one or more objects to reduce the risk of the document.

9. The apparatus of claim 8, wherein the content risk manager generates the one or more distributions of features based on the user profiles.

10. The apparatus of claim 8, wherein the content risk manager generates the one or more distributions of features based on featurized content.

11. The apparatus of claim 8, wherein the content risk manager generates the one or more distributions of features based on the user profiles and featurized content.

12. The apparatus of claim 8, wherein the content risk manager calculates the risk parameter using standard deviation and percentile.

13. The apparatus of claim 8, wherein market-based trading system is a market-based content selection system, wherein the market-based content selection system includes a content broker.

14. The apparatus of claim 8, wherein market-based trading system is a market-based layout selection system, wherein the market-based layout selection system includes a layout broker.

15. A computer readable medium providing instructions for content risk management, the instructions comprising:
generating one or more distributions of features of a document, wherein the document includes one or more objects;
calculating a risk parameter using one or more distributions of features, wherein the risk parameter defines risks of the one or more objects and a risk of the document;
interacting with a market-based trading system regarding the risk parameter, wherein the market-based trading system includes a broker; and
consummating a trade among the one or more objects using the broker to reduce the risk of the document.

16. The computer readable medium of claim 15, wherein the instructions for generating include instructions for generating the one or more distributions of features based on user profiles.

17. The computer readable medium of claim 15, wherein the instructions for generating include instructions for generating the one or more distributions of features based on featurized content.

18. The computer readable medium of claim 15, wherein the instructions for calculating include instructions for calculating the risk parameter using standard deviation and percentile.

19. The computer readable medium of claim 15, wherein the instructions for interacting include instructions for interacting with a market-based content selection system, wherein the market-based content selection system includes a content broker.

20. The computer readable medium of claim 15, wherein the instructions for interacting include instructions for interacting with a market-based layout selection system, wherein the market-based layout selection system includes a layout broker.

21. An apparatus for content risk management, comprising:
means for generating one or more distributions of features of a document, wherein the document includes one or more objects;
means for calculating a risk parameter using one or more distributions of features, wherein the risk parameter defines risks of the one or more objects and a risk of the document;
means for interacting with a market-based trading system regarding the risk parameter, wherein the market-based trading system includes a broker; and
means for consummating a trade among the one or more objects using the broker to reduce the risk of the document.

22. The apparatus of claim 21, wherein the means for calculating includes means for calculating the risk parameter using standard deviation and percentile.

23. The apparatus of claim 21, wherein the means for interacting includes means for interacting with a market-based content selection system, wherein the market-based content selection system includes a content broker.

24. The apparatus of claim 21, wherein the means for interacting includes means for interacting with a market-based layout selection system, wherein the market-based layout selection system includes a layout broker.
